(19) United States
(12) Patent Application Publication
(10) Pub. No.: US 2004/0217698 A1
(43) Pub. Date: Nov. 4, 2004

(54) High performance electrolumiscence device controlled by interface dipole layer

(75) Inventors: Jou-hahn Lee, Gyeonggi-do (KR); Moon-sup Han, Seoul (KR); Jae-cheol Lee, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd, Gyeonggi-do (KR)

(21) Appl. No.: 10/823,689

(22) Filed: Apr. 14, 2004

(30) Foreign Application Priority Data
Apr. 30, 2003 (KR) 10-2003-0027545

(51) Int. Cl. H05B 33/14; B32B 9/00; B32B 19/00

(52) U.S. Cl. 313/504; 313/506; 428/690

(57) ABSTRACT

An organic electroluminescent (EL) device is provided. The organic EL device includes a cathode and an anode, a hole transporting layer (HTL) interposed between the cathode and the anode, an organic emission material layer (EML) interposed between the HTL and the anode, and an interlayer, which is formed of a halide series material including Na, interposed between the organic EML and the cathode. The organic EL device does not include a separate electron transporting layer (ETL). The interlayer works as an interface-dipole-control layer and transports electrons and blocks holes so as to provide a high light-emitting efficiency.

### BACKGROUND OF THE INVENTION

This application claims the priority of Korean Patent Application No. 2003-27545, filed on Apr. 30, 2003, in the Korean Intellectual Property Office, which is incorporated herein in its entirety by reference.

1. Field of the Invention

The present invention relates to an organic electroluminescent (EL) device, and more particularly, to an organic EL device whose brightness and quantum efficiency are improved by enhancing the mobility of electrons.

2. Description of the Related Art

An organic EL device, one of the color display devices, is an active light-emitting display which emits light by using an organic chemical compound. Compared to a TFT-LCD device, the organic EL device has several advantages such as low manufacturing cost due to a simple structure and manufacturing process, low power consumption, small thickness, and high response speed.

The organic EL device converts electric energy into optical energy in an organic material. Holes and electrons injected from an anode and a cathode are combined in organic molecules, and excitons are generated in order to emit light.

The basic structure of the organic EL device includes a metallic cathode, an emission material layer (EML), and an anode that are sequentially stacked. The performance of the organic EL device is largely affected by changes in the structure of the layers. More specifically, the light-emitting efficiency of the organic EL device can be improved by adding various functional layers to the basic structure.

FIG. 1 illustrates an organic EL device provided by Hung et al. in U.S. Pat. No. 6,069,442. The organic EL device includes a metallic cathode (1) having a low work function, an electron transporting layer (ETL) (2), a LiF insulating layer (3), a Alq₃ (tris(8-quinolinato) aluminum) EML (4), a hole transporting layer (HTL) (5), and an indium tin oxide (ITO) anode (6).

Hung et al. tried to improve the performance of the organic EL device by varying the structure of the organic EL device. For example, the ETL (2) is interposed between the metallic cathode (1) and the LiF insulating layer (3) to improve the mobility of electrons, which are injected from the cathode, so that the performance of the organic EL device is improved. In addition, another insulating layer having a large band gap is interposed between the metallic cathode (1) and the LiF insulating layer (3) to increase quantum efficiency and the mobility of the electrons.

Another important effect of the ETL (2) is blocking of the diffusion of metallic molecules from the metallic cathode (1) to organic layers in order to prevent the attenuation of the organic EL device. However, the ETL (2) requires a thick insulating layer between the cathode (1) and the EML (4). The insulating layer improves the mobility of the electrons, however, the insulating layer reduces the injection amount of the electrons that directly relate with the performance of the organic EL device because the insulating layer operates as an electron injection barrier.

### SUMMARY OF THE INVENTION

The present invention provides a high performance electroluminescent device by effectively improving the mobility of electrons by using a NaF layer, which operates as an interface-dipole-control layer.

According to an aspect of the present invention, there is provided an organic electroluminescent (EL) device, the organic EL device comprising a cathode and an anode; a hole transporting layer (HTL) interposed between the cathode and the anode; an organic emission material layer (EML) interposed between the HTL and the anode; and an interlayer, which is formed of a halide series material including Na, interposed between the organic EML and the cathode.

The interlayer may be formed of NaF, and the thickness of the interlayer may be less than 2 nm. The organic EML may be formed of any one of Alq₃ and paraphenylene vinylene (MEH-PPV).

### BRIEF DESCRIPTION OF THE DRAWINGS

The above and other features and advantages of the present invention will become more apparent by describing in a detail exemplary embodiment thereof with reference to the attached drawings in which:

FIG. 1 is a sectional view illustrating a conventional organic electroluminescent (EL) device;

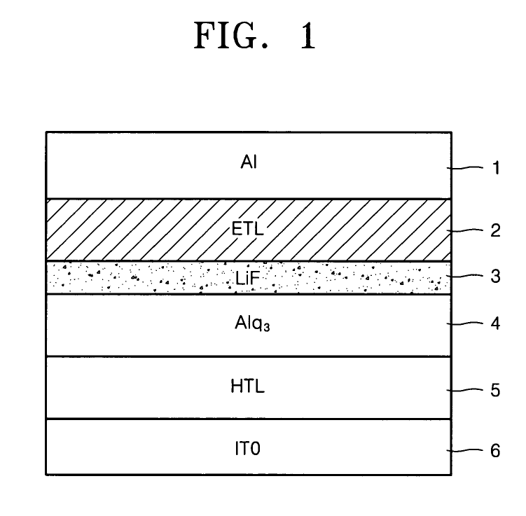

FIG. 2 is a graph illustrating an ultraviolet photoelectron spectroscopy (UPS) of a Al/NaF/Alq₃ stack structure according to the present invention;

FIG. 3 is a sectional view illustrating an organic EL device according to the present invention; and

FIGS. 4(a) and 4(b) are graphs illustrating the performances of the organic EL devices based on the changes in the thickness of a NaF interlayer, according to the present invention.

### DETAILED DESCRIPTION OF THE INVENTION

The present invention will now be described more fully with reference to the accompanying drawings, in which an exemplary embodiment of the invention is shown.

The present invention uses a compound including natrium (Na), for example, a NaF interlayer interposed, between a cathode and an emission material layer (EML) to change the electronic structure of an outmost electronic band so that the mobility of electrons is improved.

Ultraviolet photoelectron spectroscopy (UPS) investigations showed that a NaF interlayer provides a better performance than a LiF interlayer, which has been applied to a conventional organic electroluminescent (EL) device. Accordingly, the present invention substitutes the NaF interlayer for the conventional LiF interlayer.

In addition, the NaF interlayer, which is located between a metallic cathode and a low molecular EML, is substituted for a conventional electron transporting layer (ETL) and an electron injection layer (EIL) so that the brightness and the quantum efficiency of the organic EL device are improved by more than 500% compared to the case where an insulating layer is absent.

The present invention is based on the performance improving mechanism of the organic EL device by forming an interface dipole that is different from a conventional structure where a difference of work functions in the interface is emphasized. Accordingly, the present invention determines that the light-emitting mechanism of the organic EL device mainly occurs on the interlayer where the density of excitons is high. Therefore, the present invention improves the light-emitting efficiency of the device through an interface control by controlling the thickness of an insulating layer.

In an embodiment of the present invention, the light-emitting efficiency of the organic EL device is improved by controlling the thickness of a NaF interlayer, while omitting the conventional ETL and the conventional EIL. Since the mobility of holes is faster than the mobility of electrons, holes may arrive at the cathode by passing through the EML. Accordingly, the balance of electron-hole is broken so that the generation of excitons becomes difficult. As a result, the light-emitting efficiency of the organic EL device is lowered. In other words, the movement of the holes is prevented by optimizing the thickness of the NaF interlayer.

When the outmost electronic band is measured using the UPS after the NaF interlayer is accumulated on the EML, the outmost electronic band moves to the binding energy band having a high highest occupied molecular orbital (HOMO) level in the EML by NaF deposition. Therefore, it is proved that the electron injection barrier between the cathode and the EML is lowered by inserting the NaF interlayer. The lowered electron injection barrier improves the electron injection efficiency so that the light-emitting efficiency of the organic EL device is improved.

The present invention predicts the effect of the NaF interface-dipole-control layer by the UPS and applies the predicted result to the manufacture of the organic EL device so that the excellence of the NaF interlayer, which is substituted for the conventional LiF insulating layer, is proved.

The embodiment of the present invention provides the relationship between the insulating layer and the performance of the organic EL device by using the UPS. In addition, the embodiment of the present invention provides the manufacturing process of an organic EL device having a five-layer structure and the improved performance of the organic EL device using the NaF interlayer.

In the embodiment of the present invention, ITO/Alq₃/NaF/Al structure is formed in situ under an extreme vacuum state at 10⁻⁹ torr. While accumulating the layers, the changes in the electronic structures at the interfaces of the layers are measured using the UPS. After the effect of the NaF interlayer is predicted based on the measured values, an organic EL device having five layers in which the NaF interlayer is interposed between an Al cathode and Alq₃ as a low molecular organic EML is manufactured. The size of the organic EL device is 2×2 mm², and the performance of the organic EL device is measured by using a Keithley 236 source-measure unit and a calibrated Minolta CS1000 optometer.

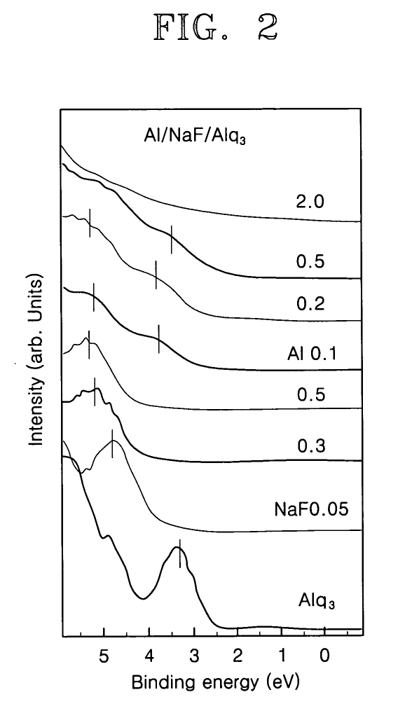

FIG. 2 is a graph illustrating the results of depositing the NaF interlayer on the organic EML, which is Alq₃, in situ, measured by using the UPS. Here, the low molecular organic EML Alq₃ of 100 nm is deposited on the ITO, and the NaF interlayer is stacked while changing the thickness of the NaF interlayer from 0.02 nm to 0.5 nm. In addition, the changes of the electronic structure band, which occur in the outmost electrons of the organic EML, are measured. At the moment of accumulating the NaF interlayer having the thickness of 0.02 nm, the HOMO level of the organic EML transferred to a high binding energy. When the NaF interlayer is accumulated to the thickness of 0.5 nm, the HOMO level of the low molecular EML transferred by about 1.7 eV. Since a portion of the lowest unoccupied molecular orbital (LUMO) moves with the transfer of the HOMO level, the electron injection barrier is predicted to be lowered to the transferred amount of the outmost electrons. The lowered electron injection barrier improves the mobility of electrons so that the light-emitting efficiency of the organic EL device improves.

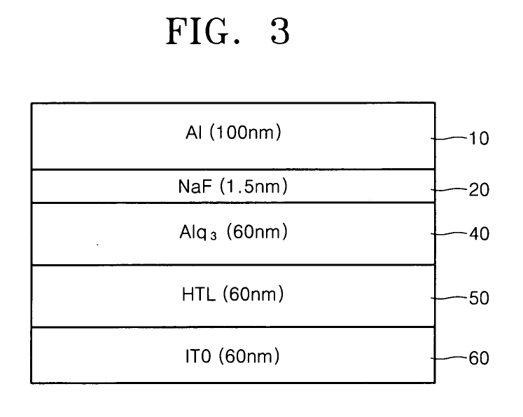

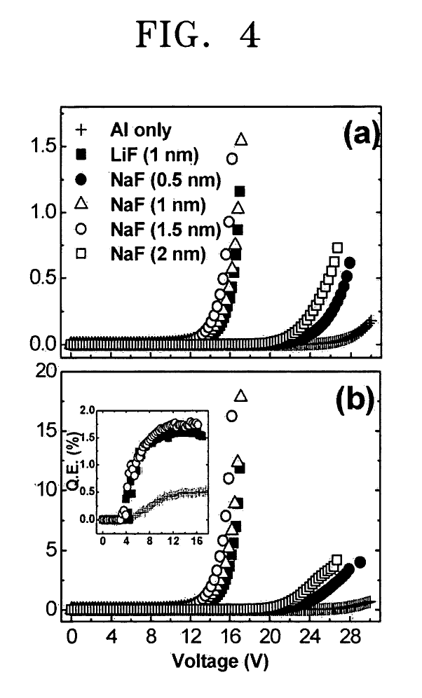

Hung et al. discloses that the ETL improves the performance and the lifespan of the organic EL device. FIG. 3 is a sectional view illustrating the organic EL device according to the embodiment of the present invention. Referring to FIG. 3, the organic EL device according to the embodiment of the present invention includes an Al metallic cathode (10) having a thickness of 100 nm, a NaF interlayer (20) having a thickness of 1.5 nm, an Alq₃ organic EML (40) having a thickness of 60 nm, a N-N′-diphenyl-N,N′-bis(3-methyphenyl)-1,1′diphenyl-4,4′-diamine (TPD) HTL (50), and an ITO anode (60). In the organic EL device according to the embodiment of the present invention, the NaF interlayer operates as a hole barrier layer, which prevents the holes from flowing to the cathode, as well as an insulating layer, while omitting the conventional ETL. In addition, the injection of electrons can be enhanced by forming an interface dipole. To this end, it is preferable that the thickness of NaF interlayer is not larger than 2 nm. When the thickness of the NaF interlayer is larger than 2 nm, the NaF interlayer operates as an insulating barrier so that the efficiency of the organic EL device significantly deteriorates, referring to FIG. 4. In other words, the thickness of the interlayer interposed between the cathode (10) and the organic EML (40) is closely related with the efficiency of the organic EL device. In addition, the existence of the interlayer and the optimum thickness of the interlayer are in a trade-off relationship.

Referring to FIG. 4, the NaF interlayer may be substituted for the conventional LiF layer. The results of performance tests of the organic EL devices are shown in FIGS. 4(a) and 4(b). Referring to FIG. 4(a), when the device is manufactured by using Al only, the current density is very low and the driving voltage is over 20V. However, when the NaF interlayer having the thickness of 0.5 nm is inserted in the device, the driving voltage is lowered to under 19V while the current density increases. When the NaF interlayer having the thickness of 1 nm is inserted to the device, the driving voltage is significantly lowered to about 8V while the current density increases. The result is similar to that where a LiF interlayer of 1 nm is inserted. When the NaF interlayer of 1.5 nm is inserted, the organic EL device provides the best performance, which is better than the result when the LiF interlayer of 1 nm is inserted. However, when the thickness of the NaF interlayer is larger than 2 nm, the performance of the organic EL device deteriorates and the driving voltage of the organic EL device increases to higher than 18V, because the thickness of the NaF interlayer operates as an insulating barrier. FIG. 4(b) illustrates the same result as that shown in FIG. 4(a). The graph of FIG. 4(b) provides the relationship between the driving voltages and the brightness for each organic EL device. When the Al metallic cathode is used only, the organic EL device requires the highest driving voltage and generates the lowest brightness. When the NaF interlayer of 1.5 nm is inserted, the organic EL device requires the lowest driving voltage and generates the highest brightness. The performance of the organic EL device including the NaF interlayer of 1.5 nm is slightly better than the performance of the organic EL device including the LiF interlayer of 1 nm. Since the brightness is in proportional relationship with the current density, the results illustrated in the graphs of FIGS. 4(a) and 4(b) are the same. The graph in the small inset of the graph of FIG. 4(b) illustrates a quantum efficiency. Here, the organic EL device using the NaF interlayer generates significantly better performance than that without the NaF interlayer.

It is asserted that the LiF interlayer operates as an insulating layer better than other insulating layers due to a large energy band gap. However, since the NaF interlayer has a larger molecular lattice constant than the LiF interlayer, the mobility of electrons may be higher in the NaF interlayer than in the LiF interlayer. Accordingly, the NaF interlayer may improve the movement of electrons in the cathode and prevent the holes, which come from the anode, from flowing to the cathode due to a large energy band gap. Therefore, the organic EL device according to the present invention provides improved performance regardless of the inclusion of the ETL.

According to the present invention, an interlayer, which is formed of a halide series material including Na, is substituted for a conventional LiF interlayer so that an organic EL device having improved performance can be obtained. In addition, the organic EL device has a novel stack structure without using the LiF interlayer and the conventional ETL, which also improves the performance of the device.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. An organic electroluminescent (EL) device comprising:
a cathode and an anode;
a hole transporting layer (HTL) interposed between the cathode and the anode;
an organic emission material layer (EML) interposed between the HTL and the anode; and
an interlayer, which is formed of a halide series material including Na, interposed between the organic EML and the cathode.

2. The organic EL device of claim 1, wherein the interlayer is formed of NaF.

3. The organic EL device of claim 1, wherein the thickness of the interlayer is less than 2 nm.

4. The organic EL device of claim 2, wherein the thickness of the interlayer is less than 2 nm.

5. The organic EL device of claim 3, wherein the organic EML is formed of any one of Alq₃ and paraphenylene vinylene (MEH-PPV).

6. The organic EL device of claim 4, wherein the organic EML is formed of any one of Alq₃ and paraphenylene vinylene (MEH-PPV).

7. The organic EL device of claim 1, wherein the organic EML is formed of any one of Alq₃ and MEH-PPV.

8. The organic EL device of claim 2, wherein the organic EML is formed of any one of Alq₃ and MEH-PPV.
